(19) United States
(12) Patent Application Publication
(10) Pub. No.: US 2026/0359870 A1
(43) Pub. Date: Nov. 12, 2026

(54) SYSTEM AND METHOD FOR COMBINED OFFER AND ORDER PROCESSING WITH DYNAMIC PRICING IN AN E-COMMERCE PLATFORM

(71) Applicant: Silenceux Francois, North Lauderdale, FL (US)

(72) Inventor: Silenceux Francois, North Lauderdale, FL (US)

(21) Appl. No.: 19/382,247

(22) Filed: Nov. 6, 2025

Related U.S. Application Data
(60) Provisional application No. 63/716,936, filed on Nov. 6, 2024.

(51) Int. Cl. G06Q 30/0601

(52) U.S. Cl. CPC G06Q 30/0611; G06Q 30/0633

(57) ABSTRACT

A combined offer and order processing system and method which operates in an e-commerce platform to automatically optimize sales of a given item that is made available and maximize the return on investment in the context of available inventory, a desired duration of a sales campaign, and trends in customer demand. The combined offer and order processing system and method described herein includes both a list price ordering module and an offer negotiation module which allows potential customers to make offers below a listed price and can automatically decide whether to accept such an offer or counter it, and also includes a dynamic pricing module with a predictive pricing element which can periodically update the listed price of an item based on real time data related to historic pricing, inventory levels, a number of pending offers, and an overall desired return on investment.

### CROSS REFERENCE TO RELATED APPLICATIONS

This application claims the benefit of and incorporates by reference co-pending U.S. provisional patent application Ser. No. 63/716,936 filed Nov. 6, 2024.

### BACKGROUND OF THE INVENTION

### Field of the Invention

This invention relates generally to computer implemented e-commerce platforms and, more particularly, to a combined offer and order processing system and method for e-commerce platforms which enables real time negotiation for offers for dynamic pricing for direct orders.

### Description of the Prior Art

It is well known that development and proliferation of electronic commerce (or “e-commerce”) for the buying and selling of goods and services has led to greatly improved efficiency in terms of shopping and transacting. While e-commerce is a relatively new activity, its general acceptance and explosive growth has coincided with the emergence and incredible growth of e-commerce platforms which provide online marketplaces that allow sellers to offer goods and services for purchase through online shopping transactions and allow buyers and potential buyers to search, view, and purchase such goods and services. As a result, e-commerce platforms which may not have existed 20 or 30 years ago now may rank as some of the largest businesses in many countries.

While e-commerce platforms have allowed for the introduction of many practices which enhance online shopping, the nature of such platforms has historically limited the ability of sellers to negotiate offers in real time with potential customers like in some traditional in person settings (like a car dealership). Furthermore, even with respect to online shopping, many legacy practices involving the setting of prices and the execution of transactions remain essentially unchanged relative to the practice which predates the proliferation of e-commerce. In this regard, there remains a need for improved offer and order processing systems and methods for e-commerce platforms which enables real time negotiation for offers for dynamic pricing for direct orders. It would be desirable for such an improved combined offer and order processing system and method for e-commerce platforms to include in its pricing system a predictive element which accounted anticipated demand, inventory, desired return on investment, and historic offers into prices. It would additionally be desirable for such an improved combined offer and order processing system and method for e-commerce platforms to include in its order processing system a batch processing trigger which accounted for target and actual pricing, the number of pending offers, and desired return on investment when processing orders.

### SUMMARY OF THE INVENTION

The present disclosure relates to a combined offer and order processing method in an e-commerce platform, comprising: providing a sales listing over a computer network, wherein the sales listing is operative to facilitate a purchase of a quantity of items that is formed from a plurality of individual items by a plurality of users on remote devices; partitioning the quantity of items into a first portion and a second portion such that some of the individual items are in the first portion and some of the individual items are in the second portion; setting at least one first sales target for the first portion and at least one second sales target for the second portion; in an initial sales period, enabling the purchase of the individual items that are in the first portion at a first list price and while also receiving a first quantity offers to purchase the individual items that are in the first portion at at least one first offer price that is lower than the first list price; in the initial sales period, selectively accepting one or more of the offers to purchase based on at least the first quantity of offers received, how many of the individual items are in the first portion, at least the first quantity of offers received and the at least one first offer price; in a subsequent sales period, enabling the purchase of the individual items that are in the second portion at a second list price and receiving a second quantity of offers to purchase the individual items that are in the second portion at at least one second offer price that is lower than the second list price; in the subsequent sales period, selectively accepting one or more of the offers to purchase based on at least the second quantity of offers received, how many of the individual items are in the second portion, at least the second quantity of offers received and the at least one second offer price; wherein the second list price is set automatically based on at least the activity in the initial sales period.

It is an object of the present disclosure to provide a combined offer and order processing system and method for an e-commerce platform which enables real time negotiation for offers for dynamic pricing for direct orders.

It is another object of the present disclosure to provide a combined offer and order processing system and method for an e-commerce platform which includes in its pricing system a predictive element which accounts anticipated demand, inventory, desired return on investment, and historic offers into prices.

It is yet another object of the present disclosure to provide a combined offer and order processing system and method for an e-commerce platform which includes in its order processing system a batch processing trigger which accounts for target and actual pricing, the number of pending offers, and desired return on investment when processing orders.

### BRIEF DESCRIPTION OF THE DRAWINGS

FIG. 1a is a schematic diagram showing the components of a combined offer and order processing system in an e-commerce platform built in accordance with the present disclosure.

FIG. 1b is a block diagram of the operative the components of a combined offer and order processing system in an e-commerce platform built in accordance with the present disclosure

FIGS. 2a and 2b show the generalized steps of a combined offer and order processing system in an e-commerce platform in accordance with the present disclosure.

FIG. 3 shows the steps involved with the waiting list management feature of a combined offer and order processing system in an e-commerce platform in accordance with the present disclosure.

FIG. 4 shows the steps involved with the automatic offer trigger of a combined offer and order processing system in an e-commerce platform in accordance with the present disclosure.

FIGS. 5a, 5b, 5c, and 5d show the steps of a combined offer and order processing system in an e-commerce platform in accordance with an embodiment of the present disclosure having the waiting list management and automatic offer trigger features enabled.

### DETAILED DESCRIPTION OF THE INVENTION

Described herein is a system and method which provides a combined offer and order processing approach to the sale of goods and services on an e-commerce platform. The combined offer and order processing system and method described herein operates to automatically optimize the sales of an item and maximize the return on investment in the context of available inventory, a desired duration of a sales campaign, and trends in customer demand. The combined offer and order processing system and method described herein includes both a list price ordering module and an offer negotiation module which allows potential customers to make offers below a listed price and can automatically decide whether to accept such an offer or counter it. The combined offer and order processing system and method described herein also includes a dynamic pricing module with a predictive pricing element which can periodically update the listed price of an item based on real time data related to historic pricing, inventory levels, a number of pending offers, and an overall desired return on investment. In this regard it can use forecasts which account for anticipated demand, inventory, desired return on investment, and historic offers to optimize sales and profitability for available items.

In addition, the combined offer and order processing system and method also features a batch processing trigger for order processing based on target and actual pricing, number of pending offers, and desired return on investment. Furthermore, the system incorporates a waiting list management feature for out-of-stock items and an automated trigger system for activating the “Make an Offer” feature based on various market conditions and inventory situations. This comprehensive approach optimizes sales, enhances inventory management, and improves customer satisfaction in e-commerce environments.

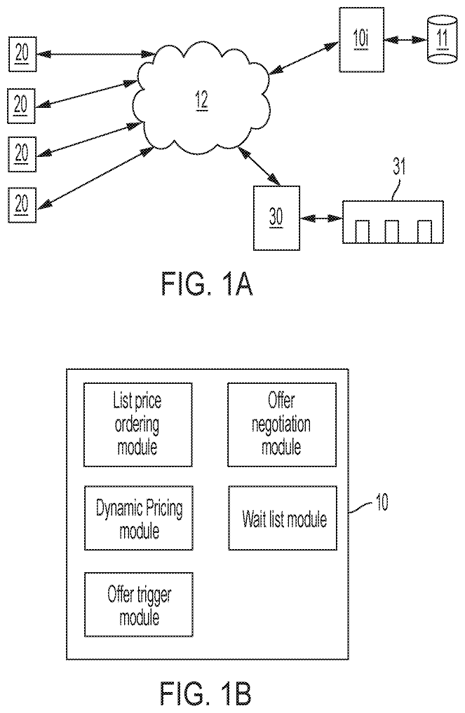

Referring now to the drawings and, in particular, FIGS. 1a and 1b, a combined offer and order processing system may be deployed through a platform server 10 that includes one or multiple databases 11 and is connected to a computer network such as the Internet 12. The platform server 10 may be accessible by a plurality of client devices 20 which may be used by customers and potential customers to engage in online shopping. The platform server 10 may additionally be accessible by a seller device 30 which may use the platform server 10 to set up an online store where items can be sold.

If such an online store offers physical items, it is contemplated that a given seller who operates the seller device 30 may separately store such physical items in an offsite warehouse 31 or other facility and may cause such physical items to be directly sent to a purchaser. It is further contemplated that while in some embodiments the given seller who operates the seller device 30 may operate or control the storage and fulfillment operations of such a warehouse 31, in other embodiments an operator of the platform server 100 may operate or control the storage and fulfillment operations of such a warehouse 31.

In any event, it may be through one or more interfaces provided by the platform server 10 that a given seller may make goods or services available for viewing and purchasing using their seller device 30, and it may be through one or more interfaces provided by the platform server 10 that users of client devices 20 may search for, view, and purchase goods or services made available by a given seller.

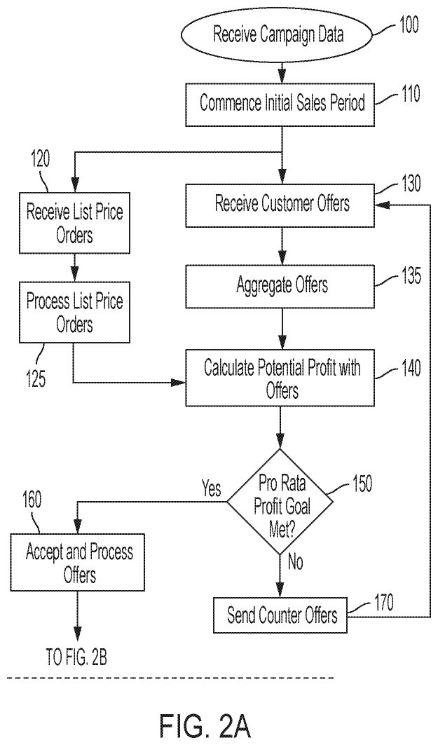

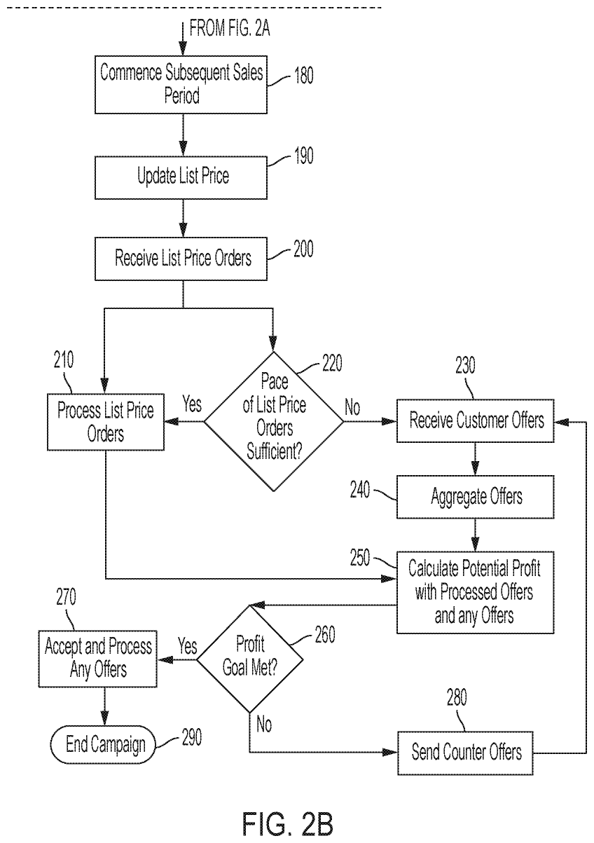

Referring now to FIGS. 2a and 2b, a method for combined offer and order processing with dynamic pricing in an e-commerce platform may begin with a platform device receiving, from a seller device, campaign data related to the sales campaign intended that a seller intends to run at step 100. The sales campaign data may include the item or thing desired to be sold, the quantity of units available to be sold during the campaign, the length of time the campaign is desired to run, a unit cost, a desired profit goal for the campaign, and an initial list price for a unit. It is contemplated that a seller providing campaign data may already have an online store set up in accordance with conventional e-commerce practices with the e-commerce platform by whom the platform server is operated.

Once the campaign data is received, the platform server may commence an initial sales period for the campaign at step 110. It is contemplated that the initial sales period may be a first of two or more total sales periods. As a part of commencing the initial sales period, the platform server may determine a pro rata profit goal for the initial sales period and partition the quantity of units available to be sold during the initial sales period based on the proportion of the length of time the campaign is desired to run that the initial sales period takes up. For example, if the initial sales period is a first of two sales periods, the platform server may define the pro rata profit goal for the initial sales period as one half of the total desired profit goal for the campaign.

During the initial sales period, the platform server may provide an interface wherein a customer, who may be a user of a client device, can immediately buy one or more units of the item being sold in the campaign at the list price or can make an offer for one or more units at a price that is lower than the list price. In accordance with the same, the platform server may then receive list price orders at step 120 and customer offers at step 130.

It is contemplated that when customer offers are received, the details related to the offer may be recorded, such as the offer amount, customer, and product ID, in an offer database accessible to the platform server. This additionally allows the platform server to segment customers based on their behavior and purchase history, and later create targeted offers and promotions.

Upon receipt of list price orders, the platform server may process the list price orders at step 125. As these orders are processed, an inventory tracking database accessible to the platform server is updated to reflect the sold items, ensuring real-time accuracy. The platform server may also send a confirmation message to the customer, notifying them of the successful transaction.

At the same time, as offers below the list price are received, the platform server may aggregate the offers at step 135 and calculate the potential profit if the aggregated offers are received, also taking into account the profit from the processed list price orders up to that point, at step 140. To be able to do this calculation, the platform server must continuously track inventory levels to ensure accurate and real-time data. In this regard, through step 140, the platform server calculates the potential return on investment (ROI) based on received offers, current inventory levels, and wholesale prices. It also may use machine learning to predict future demand, in a manner consistent to what is described below

In this regard, if the potential profit from the aggregated offers and processed list price orders equals or exceeds the pro rata profit goal for the initial sales period, as determined at step 150, the platform server may then accept and process the offers at step 160 and then fulfill the processed orders and offers. This is key because once orders and offers on the total inventory reaches the ROI threshold, the system processes the sale of all items at once, ensuring that the entire inventory is sold in a transaction occurring at or about the same time.

On the other hand, if the potential profit from the aggregated offers and processed list price orders is less than the pro rata profit goal for the initial sales period, as determined at step 150, the platform server may calculate the price that would be needed for each offer in order to respond to at least equal the pro rata profit goal, and send the calculated price to the sender of each offer as a counter offer at step 170. Once counter offers were sent, the platform server may then receive indications of whether the counter offers were accepted in a manner analogous to step 130, aggregate the acceptances in a manner analogous to step 135, calculate the potential profit in a manner analogous to step 140, and determine whether the pro rata profit goal was met in a manner analogous to step 150 (leading to either additional counter offers or acceptance of offers as described above).

If the partition of units for the initial sales period cannot be sold in this manner, the remaining units may be added to the partition of units in a subsequent sales period, with the inability to sell all units being accounted for with a dynamic price adjustment described below.

It is appreciated that in typical situations, the list price in the initial sales period would be set at a number that would cause the pro rata profit goal to be exceeded if all units partitioned for the initial sales period were sold at the list price. As such, the receipt of offers and the negotiation of offers may operate to automatically ensure the pro rata profit goal can be met or exceeded in situations wherein all units partitioned for the initial sales period were unable to be sold at the list price.

Once the initial sales period ends, the platform server may commence a subsequent sales period for the campaign at step 180. It is contemplated that the subsequent sales period may be a second of two or more total sales periods. In any event, it is appreciated that if the subsequent sales period is a second of more than two total sales periods, each period of the second of two total sales periods may operate in the same manner as the subsequent sales period described herein.

As a part of commencing the subsequent sales period, the platform server may update the list price provided in the initial campaign data at step 190 to account for real time factors such as demand demonstrated during the prior sales period, both generally and relative to the profit goal provided in the initial campaign data. During this step, the platform server may also update the profit goal if demand, as seen through list price orders and offers/counteroffers in the initial sales period, indicates that the profit goal provided is either too high or too low (the more demand, seen through more list price order and higher the price of the accepted offers/counteroffers, the higher the profit goal should be, and vice versa).

This real time price adjustment may additionally involve factors such as demand, competitor pricing, and inventory levels. This ensures optimal pricing to maximize sales and profits.

Once the list price is updated (or if it stays the same after the analysis is run), the platform server may then receive list price orders at step 200. Upon receipt of such list price orders, the platform server may process the list price orders at step 210. At the same time, the platform server may determine if the current pace of the list price orders is sufficient to meet the profit goal (without allowing any offers) at step 220. If so, the platform server may not enable the offer functionality in the subsequent sales period and simply continue to process the list price orders in the manner consistent with step 210. If not, the platform server may enable the offer functionality and receive customer offers at step 230, aggregate the offers at step 240 (in a manner analogous to step 135), and calculate the potential profit if the aggregated offers are received, also taking into account the profit from the processed list price orders up to that point in the subsequent sales period, at step 250 (in a manner analogous to step 140). In this regard, if the potential profit from the aggregated offers and processed list price orders equals or exceeds the pro rata profit goal for the subsequent sales period, as determined at step 260, the platform server would then accept and process the offers at step 270 and then fulfill the processed orders and offers. On the other hand, if the potential profit from the aggregated offers and processed list price orders is less than the pro rata profit goal for the subsequent sales period, as determined at step 260, the platform server may calculate the price that would be needed for each offer in order to respond to at least equal the pro rata profit goal, and send the calculated price to the sender of each offer as a counter offer at step 280. Once counter offers were sent, the platform server may then receive indications of whether the counter offers were accepted in a manner analogous to step 230, aggregate the acceptances in a manner analogous to step 240, calculate the potential profit in a manner analogous to step 250, and determine whether the pro rata profit goal was met in a manner analogous to step 260 (leading to either additional counter offers or acceptance of offers as described above).

Once the subsequent sales period completes in this way, if it is the second of two periods, the campaign ends at step 290. On the other hand, if the subsequent sales period is the second of more than two sales periods, another subsequent sales period will commence in the same manner until all sales periods are complete and the campaign ends at step 290.

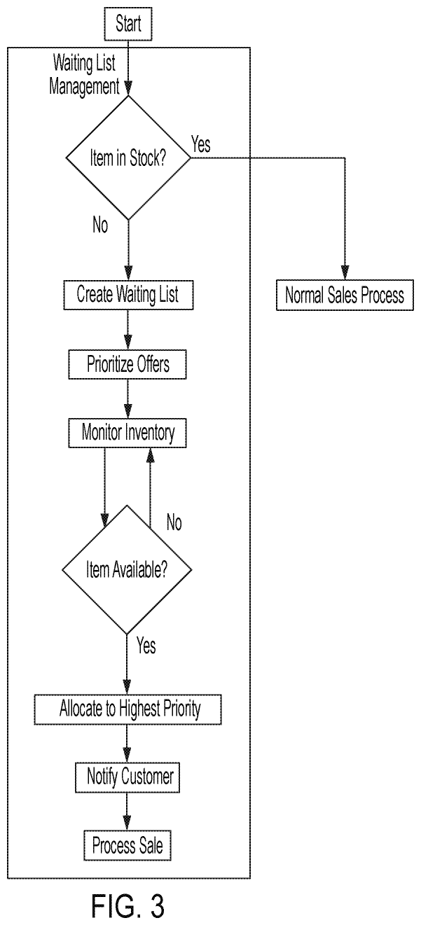

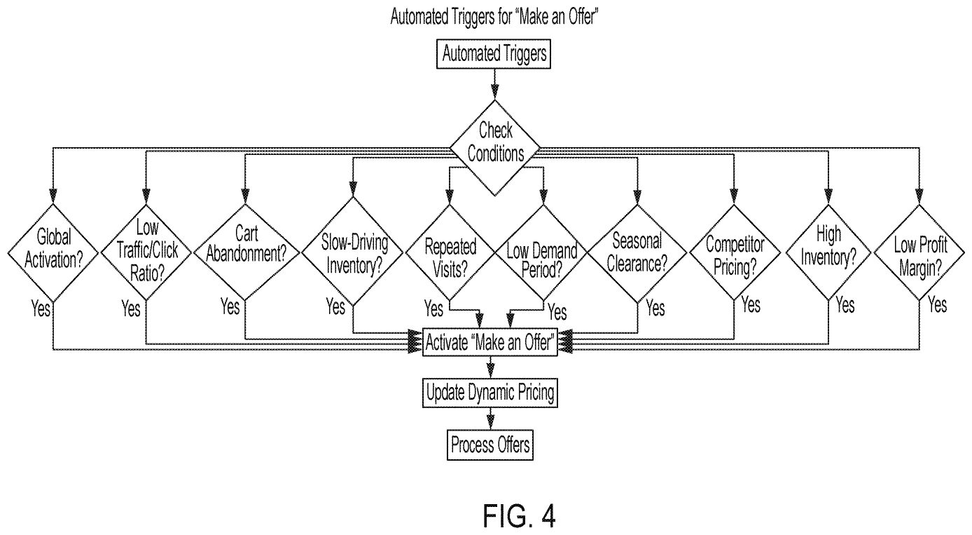

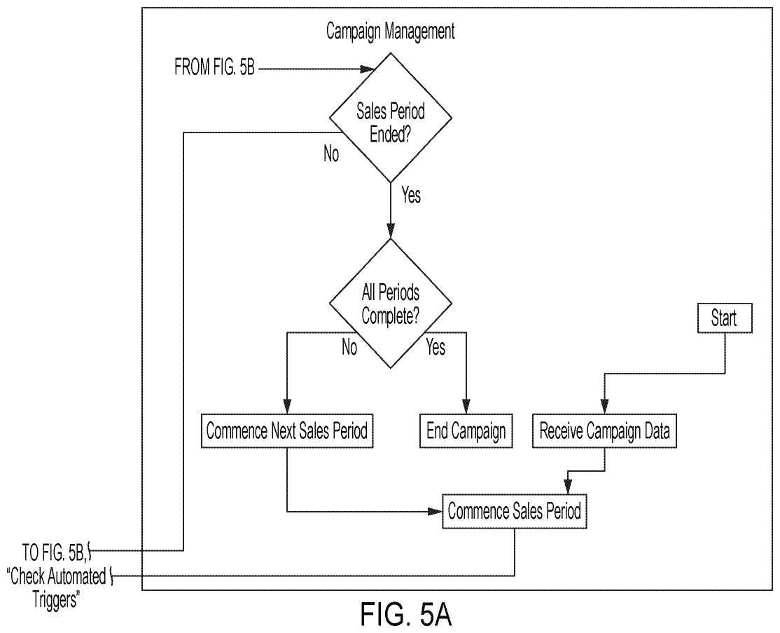

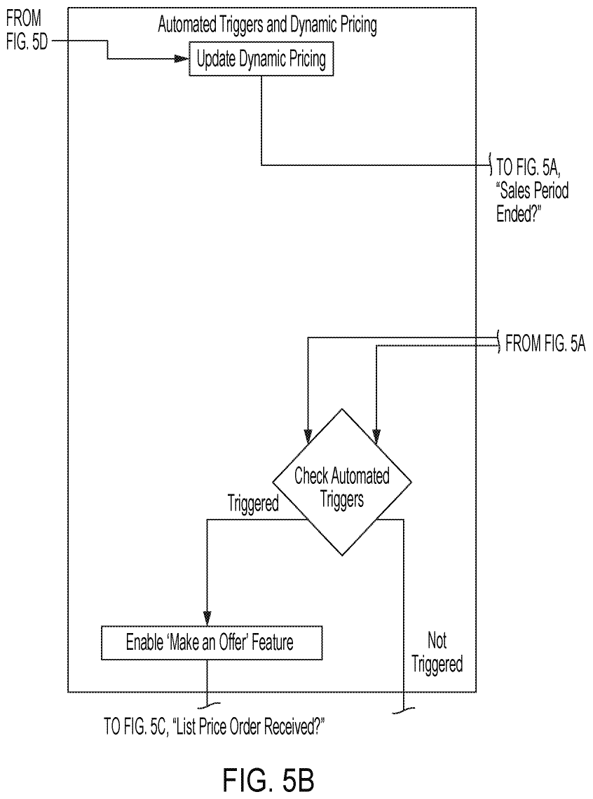

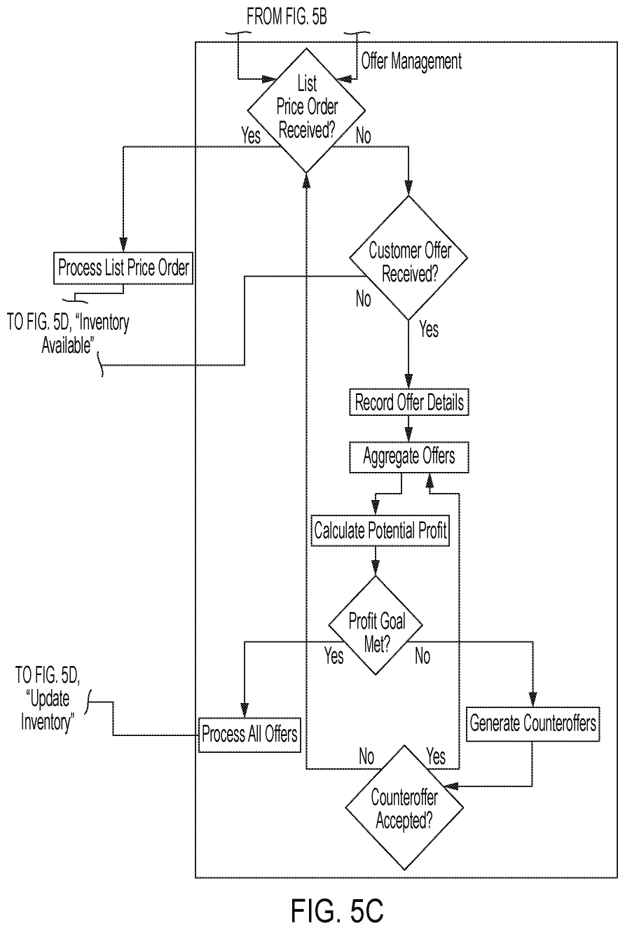

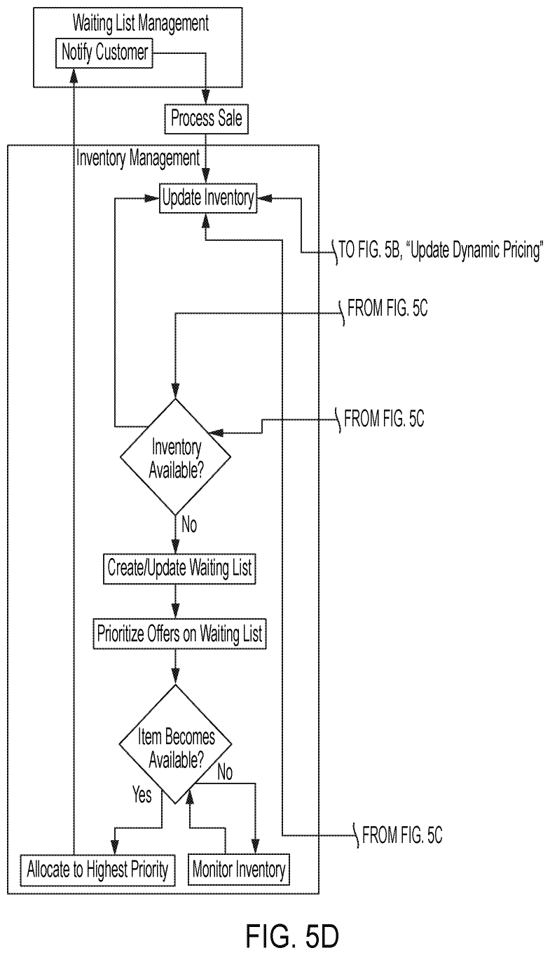

Referring now to FIGS. 3, 4, 5a, 5b, 5c, and 5d, the combined offer and order processing system may enable predictive price negotiation and automatic wait list order processing through a waiting list management module and an automatic offer trigger module.

The waiting list management module may be operable when there are out-of-stock items. This feature enhances inventory management and customer satisfaction by efficiently handling demand for items that are temporarily unavailable. The waiting list management system may include the following steps:
a. Creation of Waiting List: When an item goes out of stock, the platform server automatically creates a waiting list for that item. Customers attempting to purchase the out-of-stock item are given the option to join the waiting list.
b. Offer Prioritization: The waiting list system may prioritize customers based on several factors: offer amount (higher offers receive higher priority); timestamp (earlier offers are given precedence over later ones); and customer history (loyal customers or those with a history of completed transactions may receive preferential treatment).
c. Inventory Updates: The system continuously monitors inventory levels. When an item becomes available again, either through restocking or returns, the ability to purchase for those on the waiting list is automatically activated, with priority of access determined based on the factors discussed above.
d. Allocation of Returned Products: In the event of a product return, the system automatically allocates the returned item to the highest-priority customer on the waiting list. This process ensures efficient inventory turnover and maximizes customer satisfaction.
e. Automatic Notifications: Customers on the waiting list receive automated notifications about their position in the queue, estimated availability, and when the item becomes available for purchase.
f. Integration with Offer System: Customers on the waiting list can still make offers on the out-of-stock item. These offers are factored into their priority on the list and may be processed immediately when inventory becomes available.
g. Data Analytics: The waiting list data is analyzed to provide insights on demand for out-of-stock items, helping to inform restocking decisions and pricing strategies.

Through the automatic offer trigger module, the system incorporates a sophisticated set of automated triggers that activate a “Make an Offer” feature based on various conditions. These triggers are designed to optimize sales, manage inventory efficiently, and respond to market conditions. The automated triggers include:
a. Global Activation Trigger: This allows for manual or scheduled activation of the “Make an Offer” feature across all items or specific categories.
b. Traffic vs. Click Conversion Trigger: The system monitors the ratio of site traffic to item clicks. If this ratio is low and sales conversion is insufficient, the “Make an Offer” feature is automatically enabled to stimulate sales.
c. Cart Abandonment Trigger: When items are frequently added to carts but not purchased within a specified timeframe, the system activates the “Make an Offer” feature for these items to encourage completion of the purchase.
d. Slow-Moving Inventory Trigger: For items with slow inventory turnover, as determined by predefined thresholds, the system automatically enables the “Make an Offer” feature to accelerate sales
e. Customer Repeated Visits and Clicks Trigger: If a customer visits and clicks on an item multiple times without purchasing, the system may enable the “Make an Offer” feature specifically for that customer and item.
f. Low Demand Period Trigger: During historically low-demand periods, identified through analysis of past sales data, the system automatically activates the “Make an Offer” feature to stimulate sales.
g. Seasonal Clearance Trigger: For seasonal items nearing the end of their selling period, the system enables the “Make an Offer” feature to clear remaining inventory.
h. Competitor Price Monitoring Trigger: The system monitors competitor pricing through various means. When competitor pricing significantly undercuts the retailer's pricing, the “Make an Offer” feature is activated to maintain competitiveness.
i. Inventory Level Trigger: When inventory levels for an item exceed a certain threshold, indicating potential overstocking, the system activates the “Make an Offer” feature to help balance inventory.
j. Profit Margin Trigger: If the current profit margin for an item falls below a set threshold, the system may enable the “Make an Offer” feature to gather market data on acceptable price points. These automated triggers work in conjunction with the dynamic pricing and offer management systems described earlier, ensuring that the e-commerce platform responds efficiently to various market conditions and inventory situations. The system continuously learns from the outcomes of these triggers, refining its activation parameters over time to maximize sales efficiency and profitability.

In use, the combined offer and order processing system for an e-commerce platform is embodied in software which provides instructions to a platform server to help retailers sell their products more efficiently by allowing customers to make offers and optimizing sales through smart features. Several key features include:

Customer Offers: Customers visit the retailer's website and can make offers on products they want to buy instead of paying the listed price.

Inventory Management: The system keeps track of how much stock the retailer has and the cost of each item.

Profit Calculation: The system tracks how many gadgets are in stock and their cost, then calculates if accepting these offers will be profitable and meet the retailer's profit goals.

Automatic Sales: If the offers that have been made meet the profit goals, the system automatically processes the sales using the customers'stored payment information. When this occurs, all items are sold at once.

Counteroffers: If the offers don't meet the profit goals but many customers want the item, the system can send counteroffers to customers, suggesting a higher price than was previously offered, to try and reach the profit goals.

Demand Prediction: Using past data, such as customer behavior, such as clicks and items added to shopping carts, the system predicts whether demand for the gadget will increase next month and adjusts the price accordingly. The system uses machine learning to do this.

Dynamic Pricing: The system can automatically adjust prices based on factors like demand, competitor pricing, and inventory levels to maximize sales and profits.

Automatic Offer Enablement: If the system predicts that demand is low or that inventory will run out quickly, it can automatically turn on the option for customers to make offers.

Pacing Adjustment: If the system determines that the current sales rate (pacing) is not sufficient to sell out the inventory by a specific date, it will adjust the profit goals and enable features to boost sales.

Overall, the system helps retailers manage their inventory and sales more efficiently, ensuring they maximize profits and meet customer demand effectively.

In some embodiments, the software embodying the combined offer and order processing system for an e-commerce platform includes a bulk order handling module which allows customers to place large quantity orders and adjusts pricing and inventory allocation to account for the bulk purchases.

In some embodiments, the software embodying the combined offer and order processing system for an e-commerce platform includes a predictive demand system which uses customer behavior data (clicks, cart activity) and employs machine learning models to forecast demand and adjust pricing dynamically.

It is appreciated that the automatic offer trigger module may in some embodiments be operative to activate offers based on specified behaviors by customers, such as repeated visits without purchases, or on circumstances relating to a particular item, such as high traffic-to-click ratios without resulting sales. Advantageously, such operations make the system more robust in managing customer interactions and inventory dynamically.

Embodiments of the system and method described herein may additionally include a streamlined return system which offers customers options like restocking fees or automatic shipping label generation for returns. Streamlined returns may be provided for through a return management process which is administered by the software embodying the combined offer and order processing system for an e-commerce platform.

In some embodiments, the software embodying the combined offer and order processing system for an e-commerce platform may be operative to employ advanced customer engagement strategies, such as segmenting customers based on behavior and purchase history so as to create personalized offers or dynamic engagement tailored to specific user profiles or groups of user profiles. It is appreciated that strategies may provide for personalized promotions which can improve conversion rates.

Embodiments of the system and method described herein may additionally include in its waiting list management features the prioritizing of waiting list customers for restocking or returns of out-of-stock items and/or the dynamic adjustment of priority based behaviors like restocking or returns.

It is contemplated that the system may additionally manage loyalty points, rewards, and exclusive offers for repeat customers.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A combined offer and order processing method in an e-commerce platform, comprising:
providing a sales listing over a computer network, wherein the sales listing is operative to facilitate a purchase of a quantity of items that is formed from a plurality of individual items by a plurality of users on remote devices;
partitioning the quantity of items into a first portion and a second portion such that some of the individual items are in the first portion and some of the individual items are in the second portion;
setting at least one first sales target for the first portion and at least one second sales target for the second portion;
in an initial sales period, enabling the purchase of the individual items that are in the first portion at a first list price and while also receiving a first quantity offers to purchase the individual items that are in the first portion at at least one first offer price that is lower than the first list price;
in the initial sales period, selectively accepting one or more of the offers to purchase based on at least the first quantity of offers received and how many of the individual items are in the first portion;
in a subsequent sales period, enabling the purchase of the individual items that are in the second portion at a second list price; and
wherein the second list price is set automatically based on at least the activity in the initial sales period.

2. The combined offer and order processing method of claim 1, additionally comprising the step of, in the subsequent sales period, receiving a second quantity of offers to purchase the individual items that are in the second portion at at least one second offer price that is lower than the second list price.

3. The combined offer and order processing method of claim 2, additionally comprising the step of, in the subsequent sales period, selectively accepting one or more of the offers to purchase based on at least the second quantity of offers received and how many of the individual items are in the second portion.

4. The combined offer and order processing method of claim 3, wherein the step of selectively accepting one or more of the offers to purchase in the subsequent sales period is also based on the at least one second offer price.

5. The combined offer and order processing method of claim 3, wherein the step of selectively accepting one or more of the offers to purchase in the subsequent sales period is also based on the at least one second sales target.

6. The combined offer and order processing method of claim 3, wherein the step of selectively accepting one or more of the offers to purchase in the subsequent sales period causes any offer to purchase received in the subsequent sales period to be accepted at the same time.

7. The combined offer and order processing method of claim 1, wherein the step of selectively accepting one or more of the offers to purchase in the initial sales period is also based on the at least one first offer price.

8. The combined offer and order processing method of claim 1, wherein the step of selectively accepting one or more of the offers to purchase in the initial sales period is also based on the at least one first sales target.

9. The combined offer and order processing method of claim 1, wherein the step of selectively accepting one or more of the offers to purchase in the initial sales period causes any offer to purchase received in the initial sales period to be accepted at the same time.

10. A combined offer and order processing method in an e-commerce platform, comprising:
providing a sales listing over a computer network, wherein the sales listing is operative to facilitate a purchase of a quantity of items that is formed from a plurality of individual items by a plurality of users on remote devices;
partitioning the quantity of items into a first portion and a second portion such that some of the individual items are in the first portion and some of the individual items are in the second portion;
setting at least one first sales target for the first portion and at least one second sales target for the second portion;
in an initial sales period, enabling the purchase of the individual items that are in the first portion at a first list price and while also receiving a first quantity offers to purchase the individual items that are in the first portion at at least one first offer price that is lower than the first list price;
in the initial sales period, selectively accepting one or more of the offers to purchase based on at least the first quantity of offers received, how many of the individual items are in the first portion, at least the first quantity of offers received and the at least one first offer price;
in a subsequent sales period, enabling the purchase of the individual items that are in the second portion at a second list price and receiving a second quantity of offers to purchase the individual items that are in the second portion at at least one second offer price that is lower than the second list price;
in the subsequent sales period, selectively accepting one or more of the offers to purchase based on at least the second quantity of offers received, how many of the individual items are in the second portion, at least the second quantity of offers received and the at least one second offer price;
wherein the second list price is set automatically based on at least the activity in the initial sales period.

11. A combined offer and order processing system in an e-commerce platform, comprising:
a purchasing interface operative to provide a sales listing over a computer network, wherein the sales listing is operative to facilitate a purchase of a quantity of items that is formed from a plurality of individual items by a plurality of users on remote devices;
a platform system hosted on a server and operative to:
partitioning the quantity of items into a first portion and a second portion such that some of the individual items are in the first portion and some of the individual items are in the second portion;
set at least one first sales target for the first portion and at least one second sales target for the second portion;
provide a list price ordering module which, in an initial sales period, enables the purchase of the individual items that are in the first portion at a first list price;
provide an offer negotiation module which, in the initial sales period, receives a first quantity offers to purchase the individual items that are in the first portion at at least one first offer price that is lower than the first list price and selectively accepts one or more of the offers to purchase based on at least the first quantity of offers received and how many of the individual items are in the first portion;
in a subsequent sales period, enable through the list price ordering module the purchase of the individual items that are in the second portion at a second list price; and
automatically determine by a dynamic pricing module the second list price based on at least the activity in the initial sales period.

12. The combined offer and order processing method of claim 11, wherein the platform system is additionally operative to, in the subsequent sales period, receive through the offer negotiation module a second quantity of offers to purchase the individual items that are in the second portion at at least one second offer price that is lower than the second list price.

13. The combined offer and order processing method of claim 12, wherein the platform system is additionally operative to, in the subsequent sales period, selectively accept through the offer negotiation module one or more of the offers to purchase based on at least the second quantity of offers received and how many of the individual items are in the second portion.

14. The combined offer and order processing method of claim 13, wherein the selectively accepting of one or more of the offers to purchase in the subsequent sales period by the offer negotiation module is also based on the at least one second offer price.

15. The combined offer and order processing method of claim 13, wherein the selectively accepting of one or more of the offers to purchase in the subsequent sales period by the offer negotiation module is also based on the at least one second sales target.

16. The combined offer and order processing method of claim 13, wherein the selectively accepting of one or more of the offers to purchase in the subsequent sales period by the offer negotiation module causes any offer to purchase received in the subsequent sales period to be accepted at the same time.

17. The combined offer and order processing method of claim 11, wherein the selectively accepting of one or more of the offers to purchase in the initial sales period by the offer negotiation module is also based on the at least one first offer price.

18. The combined offer and order processing method of claim 11, wherein the selectively accepting of one or more of the offers to purchase in the initial sales period by the offer negotiation module is also based on the at least one first sales target.

19. The combined offer and order processing method of claim 11, wherein the selectively accepting of one or more of the offers to purchase in the initial sales period causes any offer to purchase received in the initial sales period to be accepted at the same time.

20. The combined offer and order processing method of claim 11, wherein the offer negotiation module is additionally operative to selectively counter at least one of one or more of the offers to purchase received during the initial sales period based on at least the first quantity of offers received, how many of the individual items are in the first portion, at least the first quantity of offers received and/or the at least one first offer price and one or more of the offers to purchase received during the subsequent sales period based on at least the second quantity of offers received, how many of the individual items are in the second portion, at least the second quantity of offers received and/or the at least one second offer price.
